(19) United States
(12) Patent Application Publication
(10) Pub. No.: US 2026/0210433 A1
(43) Pub. Date: Jul. 23, 2026

(54) DRIVETRAIN COMPONENT

(71) Applicant: Means Industries, Inc., Saginaw, MI (US)

(72) Inventors: Conner Jurs, Midland, MI (US); Jipeng Fan, Fairfax, VA (US)

(73) Assignee: Means Industries, Inc., Saginaw, MI (US)

(21) Appl. No.: 19/446,319

(22) Filed: Jan. 12, 2026

Related U.S. Application Data
(60) Provisional application No. 63/746,613, filed on Jan. 17, 2025.

(51) Int. Cl. F16H 48/24; B60K 17/02; B60K 23/02; F16H 48/08; F16H 48/30; F16H 48/40; B60K 23/04; F16H 48/22

(52) U.S. Cl. CPC F16H 48/24; B60K 17/02; B60K 23/02; F16H 48/08; F16H 48/30; F16H 48/40; B60K 2023/046; F16H 48/22

(57) ABSTRACT

A drivetrain component that includes a case, a carrier, and a differential gearset is supported in the carrier. The differential gear set includes a first differential gear connected to a first shaft and a second differential gear connected to a second shaft. A first coupling assembly mechanically couples the case to the carrier, and a second coupling assembly mechanically couples a shaft of the differential to the case.

### CROSS-REFERENCE TO RELATED APPLICATIONS

This application claims the benefit of U.S. Provisional Application No. 63/746,613, filed on January 17, 2025. The disclosure of the above application is incorporated herein by reference.

### BACKGROUND

### Field of the Invention

The present disclosure generally relates to a vehicle drivetrain and, more specifically, to a component of the vehicle drivetrain.

### Description of Related Art

Vehicles typically include a drivetrain that transfers power from a power source, for example, a combustion engine or an electric motor, to the drive wheels of the vehicle. The drivetrain may include a driveshaft and a vehicle axle connected to the driveshaft. A vehicle differential connects the drive shaft to the vehicle axle and enables each wheel to rotate at different speeds. The differential allows the shafts, for example, the wheel shafts, to spin independently of each other. The wheels rotate at different speeds while turning or cornering.

One type of differential is an open differential. Another type of differential is a locking differential. A locking differential differs from a standard or open differential by allowing the shafts or axles to be effectively locked together, as if on a common shaft, so that each wheel rotates at the same speed.

### SUMMARY

A drivetrain component including a case and a carrier. A differential gearset is supported in the carrier. The differential gear set includes a first differential gear connected to a first shaft and a second differential gear connected to a second shaft. A first coupling assembly mechanically couples the case to the carrier. A second coupling assembly mechanically couples the first shaft or the second shaft to the case.

Further areas of applicability of the present invention will become apparent from the detailed description provided hereinafter. It should be understood that the detailed description and specific examples while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a sectional view of a drivetrain component according to one example of the present invention.

FIG. 2 is a diagram of various modes or states of the drivetrain component.

FIG. 3 is a schematic view of a drivetrain component according to another example of the present invention.

FIG. 4 is a schematic view of a drivetrain component showing one mode or state of the example of FIG. 3. FIGS. 4A and 4B are cross-sectional views illustrating the positions of the locking elements for the actuator position shown in FIG. 4.

FIG. 5 is a schematic view of a drivetrain component showing another mode or state of the example of FIG. 3. FIGS. 5A and 5B are cross-sectional views illustrating the positions of the locking elements for the actuator position shown in FIG. 5.

FIG. 6 is a schematic view of a drivetrain component showing a further mode or state of the example of FIG. 3. FIGS. 6A and 6B are cross-sectional views illustrating the positions of the locking elements for the actuator position shown in FIG. 6.

FIG. 7 is a sectional view of a drivetrain component according to a further example of the present invention.

FIG. 8 is a schematic sectional view of a drivetrain component according to another example of the present invention.

### DETAILED DESCRIPTION

The following description of example(s) and/or embodiment(s) of the device or method is merely exemplary in nature and is in no way intended to limit the apparatus, system, device, or method, its application, or its uses.

Examples or disclosed embodiments of the apparatus, system, device, or method are disclosed herein; however, it is to be understood that the disclosed examples or embodiments are merely exemplary and may be embodied in various and alternative forms. The figures are not necessarily to scale; some features may be exaggerated or minimized to show details of the components. Therefore, specific structural and functional details disclosed herein are not to be interpreted as limiting but merely as a representative basis for teaching one skilled in the art to variously employ the apparatus, system, device, or method.

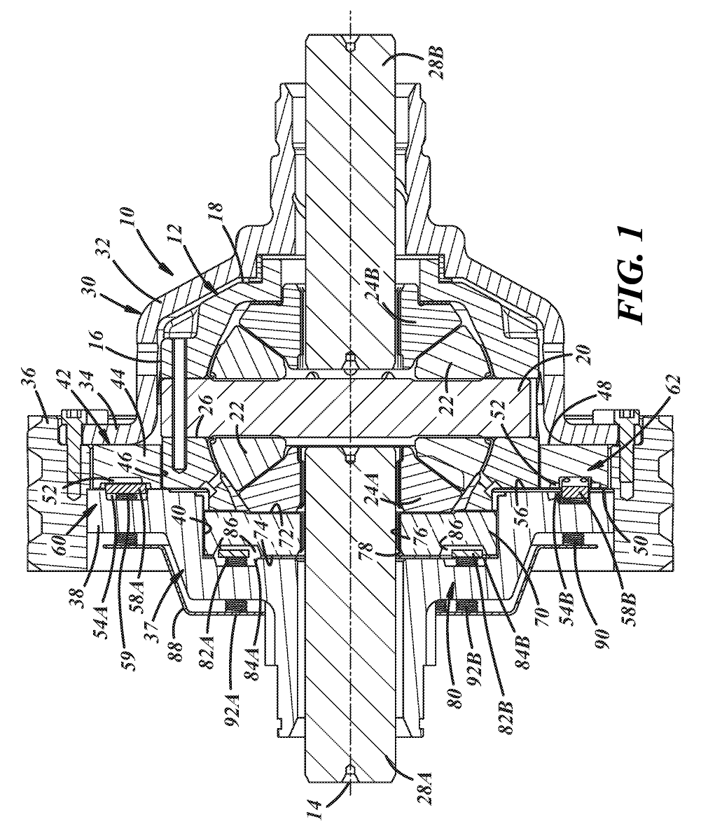

FIG. 1 illustrates one example of a drivetrain component, generally indicated at 10, including a differential with a differential disconnect and a locker or lock feature. The drivetrain component 10 may function as a differential disconnect, disconnecting drivetrain input from the drive wheels at the differential. The disconnect occurs at the differential between a differential case 30 and a carrier 12. The carrier 12 includes a differential gear set. The carrier 12 and differential gear set are aligned for rotation inside the case 30 and rotate on the same central axis 14 as the case 30. The carrier 12 rotates in the case 30 relative to and independent of the case 30.

In one example, the carrier 12 may comprise one or more pieces. The carrier 12 has a generally cylindrical shape, including an axially, in the direction of the rotational axis 14, extending annular outer peripheral surface 16 and a side surface 18. The carrier 12 is supported for rotation about the rotational axis 14. The carrier 12 includes a differential gear set having a pinion shaft 20, pinion gears 22, and differential gears 24A, 24B. The differential gears 24 connect, for example, with a splined connection, to half shafts or axles 28A, 28B connected to or part of additional axles or shafts supporting vehicle wheels. The pinion shaft 20 extends through an aperture 26 in the carrier 12 and is secured to the carrier 12. The pinion gears 22 are rotatably mounted on the pinion shaft 20 inside the carrier 12. The pinion shaft 20 and pinion gears 22 rotate with the carrier 12. The differential gears 24A, 24B engage the pinion gears 22, wherein rotation of the carrier 12 correspondingly rotates the pinion shaft 20 and pinion gears 22, causing rotation of the differential gears 24A, 24B and correspondingly the half shafts or axles 28A, 28B.

The case includes a member, seen generally at 37, having or including a plate-like portion 38, which may be referred to as a pocket plate. The member 37 is secured to a ring gear 36 and rotates with the ring gear 36. The member 37 and/or the plate-like portion or pocket plate 38 may be integral with the ring gear 36, or the individual components may be secured together, for example, by fasteners, press fitting, welding, or other suitable methods. The member 37 has an internal bore or socket 40.

The case 30 includes a cup-shaped housing 32 opposite the member 37. The cup-shaped housing 32 has a radially extending flange 34. The radial extending flange 34 connects the cup-shaped housing 32 to the ring gear 36. The carrier 12 rotates within the cup-shaped housing 32 and the internal bore or socket 40 of the member 37.

A rotatable member or notch plate, seen generally at 42, is shown in the present example as an annular member 44 having an inner peripheral surface 46 and opposing first and second side surfaces or faces 48, 50. The inner peripheral surface 46 is connected to the outer peripheral surface 16 of the carrier 12, wherein the notch plate 42 connects to the carrier 12, enabling torque transfer between the notch plate 42 and the carrier 12. The notch plate 42 may be formed integrally with the carrier 12. In addition to the splined connection, other suitable mechanisms connecting the notch plate 42 to the carrier 12 may be used, provided there is no relative rotation between the notch plate 42 and the carrier 12.

The notch plate 42 includes angularly spaced recesses or notches 52 in the second side surface or face 50 of the notch plate 42. The angularly spaced recesses or notches 52 provide a locking abutment, a part of the notch plate 42 that directly receives force or pressure. In addition to being notches 52, the locking abutments could be projections or other force or pressure receiving elements. The second side surface or face 50 of the notch plate 42 may also be referred to as a coupling face.

The pocket plate 38 includes angularly spaced recesses or pockets 54A, 54B in a side surface or face 56 of the pocket plate 38. The side surface or face 56 of the pocket plate 38 may also be referred to as a coupling face. Locking elements or struts 58A, 58B are located in the pockets 54A, 54B.

The ring gear 36 connects to a drive shaft that rotates the ring gear 36, which in turn rotates the case 30. Because the carrier 12 rotates freely in the case 30, the case 30 may rotate without the carrier 12 rotating, and no torque is transferred from the case 30 to the carrier 12. The drivetrain component 10 includes a first coupling assembly, generally indicated at 60, and a second coupling assembly, generally indicated at 62. Both coupling assemblies 60, 62 selectively couple the case 30 and carrier 12.

Coupling assembly refers to an assembly capable of producing a connection. As illustrated, the first coupling assembly 60 includes a passive locking element, for example, the strut 58A, in the pocket 54A of the pocket plate 38, which is connected to the ring gear 36. The strut 58A is continuously urged out of the pocket 54A by a resilient member or spring 59. The first coupling assembly 60 is passive because the resilient member or spring 59 constantly urges the strut 58A out of the pocket 54A in the side surface or face 56 of the pocket plate 38. The resilient member or spring constantly urges the strut 58A to a deployed position, wherein the strut 58A extends from the pocket plate 38, out of the pocket 54A, and past or above the side surface or face 56.

Because the strut 58A is in a deployed position and the side surface or face 56 of the pocket plate 38 and the second side surface or face 50 of the notch plate 42 are in close-spaced opposition, close-spaced opposition is defined as a minimum of 0 to a maximum of 2.5 millimeters, the strut 58A engages a notch 52 in the second side surface or face 50 of the notch plate 42 connecting the pocket plate 38 and notch plate 42 and, correspondingly, connecting the member 37 to the carrier 12 in one direction of rotation. The first coupling assembly 60 enables torque transmission from the case member 37 to the carrier 12 in one direction only while allowing relative rotation between the member 37 and carrier 12 in the opposite direction.

In the present example, the first coupling assembly 60 is a one-way or overrunning clutch, for example, a passive one-way clutch wherein the strut 58A constantly extends from the pocket 54A. The strut 58A, and correspondingly the first one-way clutch or first coupling assembly 60, is always deployed, creating a drive connection between rotating components, for example, the member 37 and carrier 12 when their relative rotation is in one direction, and overrunning when relative rotation is in the opposite direction and producing a drive connection when their relative rotation is in one direction and overrunning when their relative rotation is in the same direction, when the driven member rotates faster than the drive member. The overrun state effectively or passively disconnects the member 37 and the carrier 12 and, correspondingly, disconnects the drive or power source from the wheels.

In some respects, the second coupling assembly 62 is like the first coupling assembly 60. For example, the second coupling assembly 62 includes the locking element, the strut 58B, in the pocket 54B of the plate-like member, or pocket plate 38, which is connected to the ring gear 36. A resilient member or return spring positioned in the pocket 54B between the pocket plate 38 and the strut 58B applies a force on the strut 58B, urging it inward into the pocket 54B, wherein the strut 58B is at or below the side surface or face 56 of the pocket plate 38. The second coupling assembly 62 may utilize the same notches 52 in the second side surface or face 50 of the notch plate 42 as the first coupling assembly 60.

The strut 58B of the second coupling assembly 62 is an active or controllable locking element. The strut 58B moves between a deployed position and a nondeployed position. In an active or controllable assembly, an actuator assembly acts on an actuation spring 90 that engages and moves the strut 58B, in the pocket 54B of the pocket plate 38, between a nondeployed position—the strut 58B in the pocket 54B and a deployed position—the strut 58B extending outwardly from the pocket 54B and beyond or past the side surface or face 56 of the plate-like member or pocket plate 38.

Because the side surface or face 56 of the pocket plate 38 and the second side surface or face 50 of the notch plate 42 are in close-spaced opposition when the strut 58B moves to the deployed position the strut 58B engages a notch 52 in the second side surface or face 50 of the notch plate 42, connecting the pocket plate 38 and notch plate 42 and correspondingly the member 37 to the carrier 12 in one direction of rotation. The second coupling assembly 62 enables torque transmission from the member 37 to the carrier 12 in one direction only, while allowing relative rotation between the member 37 and carrier 12 in the opposite direction.

The spaced first and second pockets 54A, 54B are associated with a direction of rotation or a direction of vehicle movement — forward or reverse. As shown, both the spaced first pockets 54A and spaced second pockets 54B, housing the respective first and second struts 58A, 58B of the first coupling assembly 60 and the second coupling assembly 62, are in or on the same side surface or face 56 of the pocket plate 38.

A plurality of first struts 58A and second struts 58B are provided. The first strut 58A may alternate with the second strut 58B. It is understood that a particular number of struts may be provided, and a greater or lesser number of struts may be provided.

The notch plate 42 includes a plurality of notches 52, the respective struts 58A, 58B of the first and second coupling assemblies 60, 62 engaging the notches 52. Each notch 52 has opposing engagement surfaces at opposite ends of the notch 52. One engagement surface is configured to receive and engage the strut 58A of the first coupling assembly 60, and the other engagement surface is configured to receive and engage the strut 58B of the second coupling assembly 62. In the present example, both struts 58A, 58B act on opposite ends or engagement surfaces of the notch 52. The radial width of the respective first strut 58A and the second strut 58B may be different, with the passive or overrunning strut, the strut 58A of the first coupling assembly 60, having a greater width. The notch 52 may also include ramp surfaces on each side, forming a narrow portion adjacent to the engagement surface associated with the strut 58B of the second coupling assembly 62. The ramp surfaces provide side or lateral support for the strut 58B and cooperate with the strut 58A during overrunning.

The first and second coupling assemblies 60, 62 operate, in connection with the member 37 and the carrier 12, to connect and disconnect the member 37 and the corresponding ring gear 36 with and from the carrier 12.

The drivetrain component 10 includes a third coupling assembly 80. The third coupling assembly 80 operates to connect and disconnect a half shaft or axle 28A and the member 37. The third coupling assembly 80 includes active or controllable locking elements or struts; for example, the strut 82A in the pocket 84A and the strut 82B in the pocket 84B of the pocket plate 38. A resilient member or return spring positioned in the pocket 84A between the pocket plate 38 and the strut 82A applies a force on the strut 82A, urging it inward into the pocket 84A, wherein the strut 82A is at or below the side surface or face 56 of the pocket plate 38. Similarly, a resilient member or return spring positioned in the pocket 84B between the pocket plate 38 and the strut 82B applies a force on the strut 82B, urging it inward into the pocket 84B, wherein the strut 82B is at or below the side surface or face 56 of the pocket plate 38.

The drivetrain component 10 further includes a second annular or disc-shaped member 70. The second annular or disc-shaped member 70 includes a first side surface 72, a second side surface 74, and an inner peripheral surface 76, including a plurality of splines 78. The second annular or disc-shaped member 70 includes a plurality of notches 86 in the second side surface 74. The second annular or disc-shaped member 70 is positioned in the internal bore or socket 40 between the pocket plate 38 and the carrier 12. The second annular or disc-shaped member 70 rotates about the axis 14 independent of the pocket plate 38 and carrier 12. As shown, the left side differential gear 24A and second annular or disc-shaped member 70 are adjacent to one another and are fixed to the left side half shaft or axle 28A via a splined connection. As the left side differential gear 24A rotates, it rotates both the second annular or disc-shaped member 70 and the left side half shaft or axle 28A.

The third coupling assembly 80 includes the notches 86 of the second annular or disc-shaped member 70, wherein the respective struts 82A, 82B of the third coupling assembly 80 engage the notches 86. Each notch 86 has opposing engagement surfaces at opposite ends of the notch 86. One engagement surface is configured to receive and engage the strut 82A, and the other engagement surface is configured to receive and engage the strut 82B. While the locking elements or struts 82A, 82B of the third coupling assembly 80 utilize the same notches 86 in the second side surface 74 of the second annular or disc-shaped member 70. They may utilize different notches, spaced circumferentially or radially, and/or notches having different notch configurations or shapes.

The third coupling assembly 80 connects the ring gear 36 to the left side half shaft or axle 28A and enables torque transmission from the ring gear 36 and pocket plate 38 through the locking elements or struts 82A, 82B to the second annular or disc-shaped member 70, the notch plate that includes the notches 86, to left-side half shaft 28 connected via the splined connection to the second annular or disc-shaped member 70. Torque is transmitted in both directions when both locking elements or struts 82A, 82B are deployed.

The drivetrain component 10 includes an actuator that operates or controls the second and third coupling assemblies 62, 80. In one example, the actuator may be a three-position actuator operative to move a control member between three discrete positions. The control member may include a translator and a spring plate 88. The translator reacts to a force generated by the actuator and moves the spring plate 88, and corresponding actuation springs 90, 92A, 92B along the rotational axis 14. Each actuation spring 90 of the second locking structure 62 has a free end portion adapted to move within a passage in the pocket plate 38 and engage the strut 58B of the second coupling assembly 62. Each actuation spring 92A, 92B of the third coupling assembly 80 has a free end portion adapted to move within a passage in the pocket plate 38 and engage respective struts 82A, 82B of the third coupling assembly 80.

A translational force moves the translator structure linearly. The translator structure is operatively connected to the actuation springs 90, 92A, 92B via the spring plate 88, which linearly moves the actuation springs 90, 92A, 92B.

The first and second coupling assemblies 60, 62 act with the carrier 12 and case 30, providing a differential disconnect. The third coupling assembly 80 creates a locking differential by coupling the ring gear 36 and/or case 30 and a half shaft or axle 28A. Using the differential disconnect and locking differential provides a differential having a disconnect for efficiency and a locker for locking both axles together, whereby they both rotate together at the same speed.

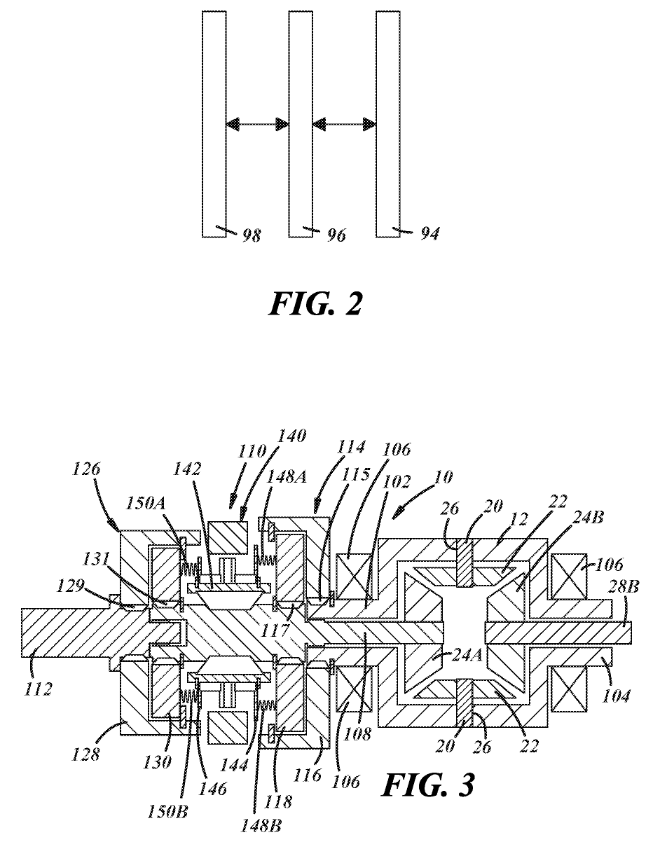

FIG. 2 illustrates one example of the modes of the differential, corresponding to the position of the translator of a three-position actuator. The translator selectively shifts laterally along the rotational axis 14, between a first position corresponding to a first mode 94 of the drivetrain component 10, a second position corresponding to a second mode 96 of the drivetrain component 10, and a third position corresponding to a third mode 98 of the drivetrain component 10. The first mode 94 may be a disconnect or disconnected mode in which struts 58A passively control the operating mode of the drivetrain component 10, and the struts 58B are in a nondeployed position. In the first mode 94, the case 30 overruns the carrier 12 in the forward direction, disconnecting the carrier 12 from the case 30. The second mode 96 may be a connected and unlocked mode wherein the struts 58A, 58B are in a deployed position and the struts 82A, 82B are in a nondeployed position. In the second mode 96, the carrier 12 is connected to the case 30, and torque is transferred in both the forward and reverse direction. The third mode 98 may be a connected and locked mode in which the struts 58A, 58B are in a deployed position, and the struts 82A, 82B are in a deployed position. In the third mode 98, the carrier 12 is connected to the case 30, and torque is transferred in both the forward and reverse directions. In the third mode 98, the ring gear 36 and/or case 30 is connected to the wheel axle, for example the left side half shaft or axle 28A, providing a "locker" or locked differential.

FIGS. 3-6 schematically illustrate another example of a vehicle drivetrain component 10 having a differential disconnect and a locker or lock feature, and its operating modes. As shown in FIG. 3, the drivetrain component 10 includes a differential having a carrier 12. The carrier 12 includes a differential gear set having a pinion shafts 20, pinion gears 22, and differential gears 24A, 24B. The pinion shafts 20 extend through apertures 26 in the carrier 12 and are secured to the carrier 12. The pinion gears 22 are rotatably mounted on the pinion shafts 20 inside the carrier 12. The pinion shaft 20 and pinion gears 22 rotate with the carrier 12. A left side member or shaft 108 connects to the differential gear 24A, and the differential gear 24B is connected to a half shaft or axle 24B. The differential gears 24A, 24B engage the pinion gears 22, wherein rotation of the carrier 12 causes the pinion shaft 20 and pinion gears 22 to rotate, thereby causing rotation of the differential gears 24A, 24B and, correspondingly, the left side member or shaft 108 and/or the half shaft or axle 24B. A ring gear, not shown, connected to the carrier 12, operates to rotate the carrier 12.

The carrier 12 includes first and second axially extending collars 102, 104. Bearings 106 support the carrier 12 for rotational movement. A coupling mechanism, seen generally at 110, connects the member or shaft 108 to a half shaft or output shaft 112.

The coupling mechanism 110 includes a first coupling assembly 114 having a first coupling plate 116 connected, for example, by a spline connection 115, to the first axially extending collar 102, and a second coupling plate 118 connected, for example, by a spline connection 117, to the member or shaft 108. The first coupling assembly 114 further includes coupling elements, for example, locking elements, struts, friction plates, or dog-clutch elements. When deployed, the coupling elements couple the first plate 116 and the second plate 118 and correspondingly connect the shaft or member 108 to the carrier 12.

The coupling mechanism 110 includes a second coupling assembly 126 having a first coupling plate 128, connected, for example, by a spline connection 129, to the half shaft or output shaft 112, and a second coupling plate 130, connected, for example, by a spline connection 131, to the member or shaft 108. The second coupling 126 assembly includes coupling elements, for example, locking elements, struts, friction plates, or dog-clutch elements. The second coupling assembly 126 further includes locking elements or struts 132A, 132B in the pockets 134A, 134B of the second pocket plate 130. When deployed, the coupling elements couple the first coupling plate 128 and the second coupling plate 130, and, correspondingly, connect the member or shaft 108 to the half shaft or output shaft 112.

The coupling mechanism 110 includes an actuator 140, for example, a three-position linear actuator, operating to control the first and second coupling assemblies 114, 126. The actuator 140 operates through a translator 142 to move a first spring plate 144 and a second spring plate 146. The first spring plate 144 acts on the springs 148A, 148B, and is operative to move the coupling elements associated with the first coupling assembly 114 between an engaged and nonengaged position. The second spring plate 146 acts on springs 150A, 150B, and is operative to move the coupling elements associated with the second coupling assembly 126 between an engaged and a nonengaged state.

The translator structure, or translator 142, moves upon receiving a force, which linearly moves the translator structure, and, correspondingly, the actuation springs 148A, 148B, 150A, 150B within their respective passageways in the coupling plates 118, 130.

The first coupling assembly 114 acts with the member or shaft 108 and the carrier 12. The second coupling 126 assembly acts with the member or shaft 108 and the half shaft or output shaft 112. The first and second coupling assemblies 114, 126, together with the carrier 12 and differential gearset, the member or shaft 108, and the half shaft or output shaft 112, provide a drivetrain component 10 having a differential disconnect and a locking differential.

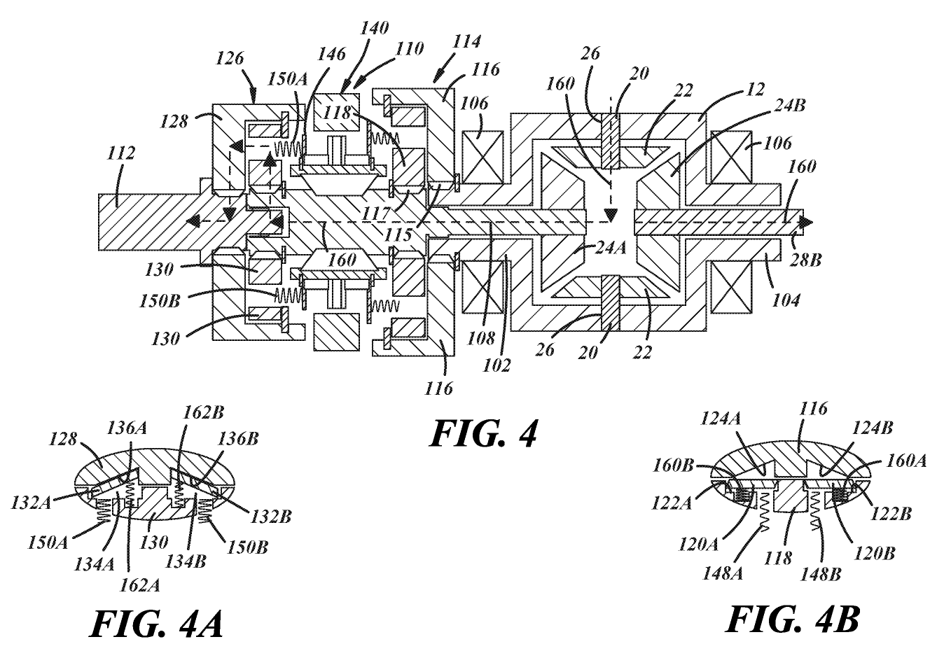

FIGS. 4-6 illustrate one example of the drivetrain component 10. The first coupling plate 116 of the first coupling assembly 114 is a notch plate having notches 124A, 124B, and the second coupling plate 118 of the first coupling assembly 114 is a pocket plate having pockets 122A, 122B. The coupling elements of the first coupling assembly 114 are locking elements or struts 120A, 120B disposed in the pockets 122A, 122B of the first coupling plate or pocket plate 118. When deployed, the locking elements or struts 120A, 120B engage the corresponding notches 124A, 124B to couple the second coupling plate or notch plate 116 to the first coupling plate or pocket plate 118 and, correspondingly, connect the shaft or member to the carrier 12. The first coupling plate 128 of the second coupling assembly 126 is a notch plate with notches 136A, 136B, and the second coupling plate 130 of the second coupling assembly 126 is a pocket plate with pockets 134A, 134B. The coupling elements of the second coupling assembly 126 are locking elements or struts 132A, 132B disposed in the pockets 134A, 134B of the second coupling or pocket plate 130. When deployed, the locking elements or struts 132A, 132B engage corresponding notches 136A, 136B to couple the first coupling or notch plate 128 and the first coupling or pocket plate 130, and, correspondingly, connect the member or shaft 108 to the half shaft or output shaft 112.

The actuator 140, for example, a three-position linear actuator, controls the first and second coupling assemblies 114, 126. The actuator 140 operates through a translator 142 to move a first spring plate 144 and a second spring plate 146. The first spring plate 144 acts on the springs 148A, 148B, and is operative to move the locking elements or struts 120A, 120B between a nondeployed position and a deployed position. The second spring plate 146 acts on springs 150A, 150B, and is operative to move the locking elements or struts 132A, 132B between a deployed and a nondeployed position. The actuation springs 148A, 148B of the first coupling assembly 114 apply a force against the return springs 160A, 160B, with the return springs 160A, 160B pushing the struts 120A, 120B inward into the pockets, into the nondeployed position. The actuation springs 150A, 150B of the second coupling assembly 126 apply a force acting against the advance springs 162A, 162B. The advance springs 162A, 162B push the struts 132A, 132B outward of the pocket 136A, 136B, the deployed position.

FIGS. 4-6 illustrate various modes of the drivetrain component 10. As illustrated, the actuator 140 moves between three positions. FIG. 4 shows the translator 142 positioned in the middle or center – Mode 1 in this example, the actuator springs 150A, 150B of the second coupling assembly 126 are retracted and the advance springs 162A, 162B act on the locking elements or struts 132A, 132B and deploy them. In the middle position, the actuator springs 148A, 148B of the first coupling assembly 114 are retracted, wherein the return springs 160A, 160B act on the struts 120A, 120B to position them in the pockets 122A, 122B. In this position, the differential is connected, the half shaft or output shaft 112 is connected to the member or shaft 108. The locking differential or locker is off or disconnected, and the member or shaft 108 is not connected to the carrier 12. Torque is transferred along the path shown by the line/arrow 160.

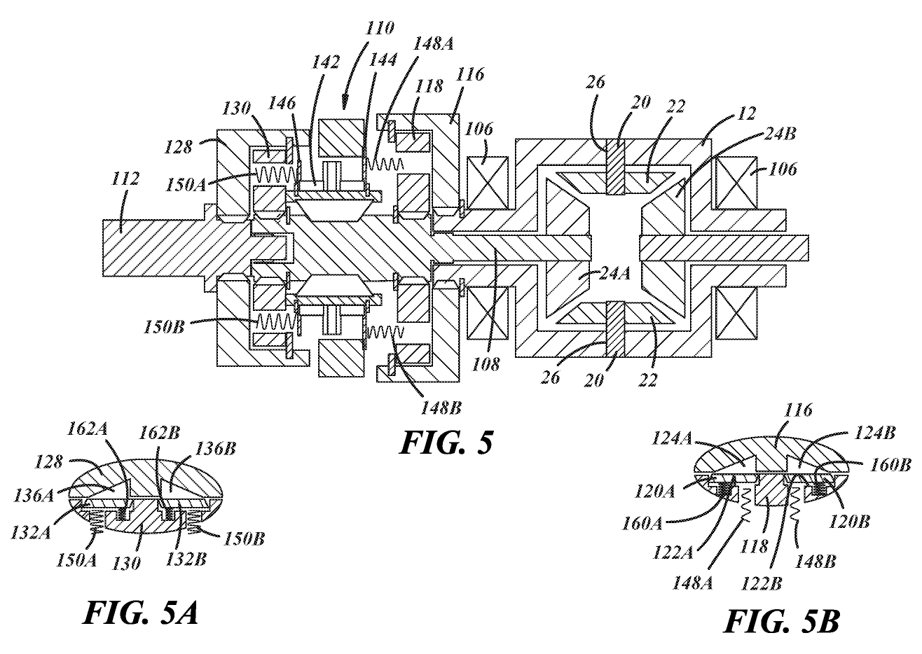

FIG. 5 shows the translator 142 positioned at the far left – Mode 2 in this example, wherein the actuator springs 150A, and 150B of the second coupling assembly act on the locking elements or struts 132A, 132B, overcome the force of the advance springs 162A, 162B and move the locking elements or struts 132A, 132B from the deployed position shown in FIG. 5 to a nondeployed position, wherein the locking elements or struts 132A, 132B are in the pockets 134A, 134B. In the far-left position, the actuator springs 148A, 148B of the first coupling assembly 114 are retracted, wherein the return springs 160A, 160B act on the struts 120A, 120B to position them in the pockets 122A, 122B. In this position, the differential is disconnected, the half shaft or output shaft 112 is not connected to the member or shaft 108, and the locking differential or locker is off or disconnected. The member or shaft 108 is not connected to the carrier 12. No torque is transferred as the half shaft is disconnected and the locker is disconnected.

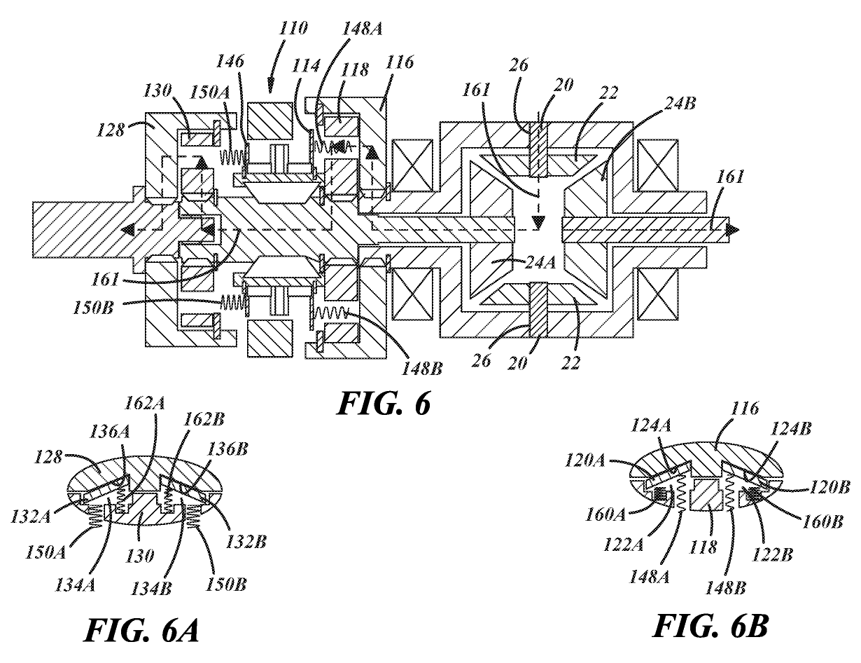

FIG. 6 shows the translator 142 positioned at the far right – Mode 3 in this example, wherein the actuator springs 150A, 150B of the second coupling assembly 126 are retracted and the advance springs 162A, 162B act on the locking elements or struts 132A, 132B and deploy them. In the far-right position, the actuator springs 148A, 148B of the first coupling 114 assembly act on struts 120A, 120B, moving them out of the pockets 122A, 122B to a deployed position wherein they engage the notches 124A, 124B, and couple the member or shaft 108 with the carrier 12. In this position, the differential is connected, the half shaft or output shaft 112 is connected to the member or shaft 108, and the locking differential or locker is on or connected, the member or shaft 108 is connected to the carrier 12. Torque is transferred along the path shown by the line/arrow 161.

The second coupling assembly 126 creates a break between the member or shaft 108 and the half shaft or output shaft 112, forming a disconnect by spinning the differential gearset. The first coupling assembly 114 locks the carrier 12 to the member or shaft 108 and the second coupling assembly 126 locks the carrier 12 to the half shaft or output shaft 112 whereby the carrier 12 is locked to the half shaft or output shaft 112 creating a locking differential.

While the second coupling assembly 126 discloses both struts 132A, 132B as controllable, one of the struts could be passive, providing a passive forward one-way clutch function.

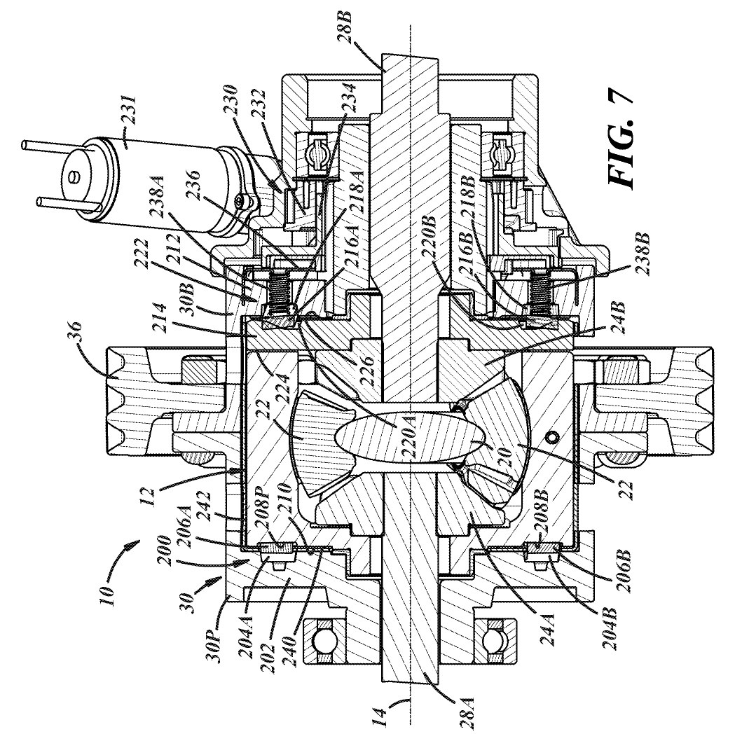

FIG. 7 illustrates a further example of a drivetrain component 10 having a differential disconnect and a locker or lock feature. The drivetrain component 10 includes a case 30, a ring gear 36 connected to the case 30, and a carrier 12 rotatable supported in the case 30 for rotation about the rotational axis 14. The case 30 includes left and right cup sections 30A, 30B that enclose the carrier 12. The carrier 12 includes a differential gear set having a pinion shaft 20, pinion gears 22, and differential gears 24A, 24B. The differential gears 24A, 24B connect, for example, with a splined connection to first and second half shafts or axles 28A, 28B. The pinion shaft 20 is secured to the carrier 12. The pinion gears 22 are rotatably mounted on the pinion shaft 20 inside the carrier 12. The pinion shaft 20 and pinion gears 22 rotate with the carrier 12. The differential gears 24A, 24B engage the pinion gears 22, wherein rotation of the carrier 12 correspondingly rotates the pinion shaft 20 and pinion gears 22, causing rotation of the differential gears 24A, 24B and correspondingly the half shafts or axles 28A, 28B.

The drivetrain component 10 includes a first coupling assembly, seen generally at 200. The first coupling assembly 200 includes the left cup section 30A having a radially extending portion forming a pocket plate 202. The pocket plate 202 includes a plurality of pockets 204A, 204B. Locking elements or struts 206A, 206B positioned in the pockets 204A, 204B interact with corresponding notches 208A, 208B in a side surface 218 of the carrier 12. When deployed, the locking elements or struts 206A, 206B engage the corresponding notches 208A, 208B to couple the case 30 to the carrier 12 and correspondingly transfer torque from the ring gear 36 to the respective half shafts or axles 28A, 28B. The first coupling assembly 200 operates to provide the drivetrain component 10 with a differential disconnect.

The right cup section 30B of case 30 has a radially extending portion that forms a pocket plate 212. The drivetrain component 10 also includes an annular or disc-shaped member 214 having a first side surface 224 and a second side surface 226. The annular or disc-shaped member 214 is positioned between the pocket plate 212 of the right cup section 30B and the carrier 12. The annular or disc-shaped member 214 rotates about the axis 14 independent of the pocket plate 212 and carrier 12. As shown, both the differential gear 24B and the annular or disc-shaped member 214 are adjacent to one another. They are fixed together, for example by a splined connection, wherein they rotate together. As the differential gear 24B and annular or disc-shaped member 214 rotate, the half shaft or axle 28B also rotates.

The drivetrain component 10 also includes a second coupling assembly, seen generally at 222. The second coupling assembly 222 includes locking elements or struts 216A, 216B positioned in pockets 218A, 218B in the pocket plate 212. The locking elements or struts 216A, 216B engage notches 220A, 220B in the second side surface 226 of the annular or disc-shaped member 214. The annular or disc-shaped member 214 may be referred to as a notch plate.

The second coupling assembly 222 connects the ring gear 36 to the half shaft or axle 28B through the annular or disc-shaped member 214. It enables torque transmission from the ring gear 36 and the pocket plate 212, through the locking elements or struts 216A, 216B, to the annular or disc-shaped member 214 and either the differential gear 24B or the half shaft or axle 28B.

The drivetrain component includes an actuator, seen generally at 230. The actuator 230 is one example of an actuator suitable for use with the drivetrain component 10. The actuator 230 includes a drive mechanism, for example, a motor 231, The drive mechanism of the actuator 230 controls deployment and non-deployment of the locking elements or struts 206A, 206B of the first coupling assembly 200 and deployment and non-deployment of the locking elements or struts 216A, 216B of the second coupling assembly 222.

FIG. 7 shows a selector plate 240, located between the pocket plate 202 and the side surface 210 of the carrier 12, that retains the locking elements or struts 206A, 206B in the pockets 204A, 204B of the pocket plate 202. The motor 231 of the drive mechanism 230 is coupled to the selector plate 240 by a cylindrical member 242 that rotates about the axis 14 and moves or rotates the

selector plate 240 to align the openings in the selector plate 240 with the corresponding locking elements or struts 206A, 206B of the first coupling assembly 200. When the openings in the selector plate 240 and the corresponding locking elements or struts 206A, 206B align, the locking elements or struts 206A, 206B extend through and past the opening in the selector plate 240 and engage the notches 208 in the side surface 210 of the carrier 12.

The locking elements or struts 206A, 206B, and the selector plate 240 provide a selectable or controllable one-way clutch that produces a connection between rotating or stationary components in one direction and overruns in the opposite direction. In one example, the locking elements or struts 206A and the locking elements or struts 206B are both oriented and transmit torque in the same direction, for example, when deployed both locking elements or struts 206A and locking elements or struts 206B engage and transmit torque in a direction corresponding with forward vehicle motion and overrun and transmit no torque in a direction corresponding with reverse vehicle motion.

FIG. 7 shows the drive mechanism, for example the motor 231, acting on a rotatable cam member 232, which in turn actuates a translator 234. The translator includes a spring plate 236 acting on actuation springs 238A, 238B. The actuation springs 238A, 238B act on the locking elements or struts 216A, 216B of the second coupling assembly 222 to position them in either a deployed or nondeployed position. The actuation springs 238A, 238B apply a force acting against either the return or advance springs. The advance spring pushes the locking elements or struts 216A, 216B outward of the pockets 218A, 218B into the deployed position, and the return springs push the locking elements or struts 216A, 216B inward into the pocket into the nondeployed position.

The locking elements or struts 216A, 216B and the actuation springs 238A, 238B provide a selectable or controllable one-way clutch that produces a connection between rotating or stationary components in one direction and overruns in the opposite direction. In one example, the locking elements or struts 216A and the locking elements or struts 216B are both oriented and transmit torque in the same direction, for example, when deployed both locking elements or struts 216A and the locking elements or struts 216B engage and transmit torque in a direction corresponding with reverse vehicle motion and overrun and transmit no torque in a direction corresponding with forward vehicle motion.

The actuator 230 and the first and second coupling assemblies 200, 222 provide multiple operating modes.

A forward mode wherein the locking elements or struts 206A, 206B are deployed, transferring torque in a direction associated with forward vehicle motion, and the locking elements or struts 216A, 216B are nondeployed, and transfer no torque in either direction, either forward or reverse. In the forward mode, the carrier 12 is connected to the case 30 is connected and transfers torque to the half shafts or axles 28A, 28B in a direction corresponding to forward vehicle motion.

A reverse mode wherein the locking elements or struts 216A, 216B are deployed, transferring torque in a direction associated with reverse vehicle motion, and the locking elements or struts 206A, 206B are nondeployed, and transfer no torque in either direction, either forward or reverse. In the reverse mode, the case 30 is connected to the half shaft 28B and transfers torque to the half shaft 28B in a direction corresponding to reverse vehicle motion. Because the locking elements or struts 206A, 206B are nondeployed, the torque associated with reverse vehicle motion is transmitted through the half shaft 28B only, while the differential gears 22 compensate for any variance in rotational speed of the respective half shafts or axles 28A, 28B.

A forward and reverse locked mode wherein the locking elements or struts 206A, 206B are deployed, transferring torque in a direction associated with forward vehicle motion, the locking elements or struts 216A, 216B are also deployed, transferring torque in a direction associated with reverse vehicle motion. Deploying both the locking elements or struts 206A, 206B and the locking elements or struts 216A, 216B produces a locked differential wherein the shafts or axles 28A, 28B are effectively locked together so that each wheel rotates at the same speed, in both directions forward and reverse.

In the one example, the actuator is a three-position cam actuator, with the cam 232 acting on the translator 234 and the cylindrical member 242, and correspondingly the selector plate 240. Multiple actuators may also be used, wherein one actuator operates the first coupling assembly 200 and the second actuator operates the second coupling assembly 222.

Another operating mode of the actuator 230 and the first and second coupling assemblies 200, 222 includes a fully disengaged mode wherein the locking elements or struts 206A, 206B are nondeployed, transferring no torque in a direction associated with forward vehicle motion, and the locking elements or struts 216A, 216B are also nondeployed, transferring no torque in a direction associated with reverse vehicle motion. In this operating mode, the actuator 230 interacts with the translator 234 and the cylindrical member 242, and correspondingly the selector plate 240, to move the respective locking elements or struts of the first coupling assembly 200 and second coupling assembly 222 to a nondeployed position.

An alternative example of the drivetrain component 10 shown in FIG. 7 includes the locking elements or struts 206A and the locking elements or struts 206B both oriented and transmitting torque in opposite directions, for example, when deployed the locking element or strut 206A engages and transmits torque in a direction corresponding with forward vehicle motion and the locking element or strut 206B engages and transmits torque in a direction corresponding with reverse vehicle motion.

In the alternative example, the drive mechanism of the actuator 230 individually controls deployment and non-deployment of the locking elements or struts 206A, 206B of the first coupling assembly 200. The actuator 230 moves or rotates the selector plate 240 to align the openings in the selector plate 240 with the corresponding locking elements or struts 206A, 206B. When the openings in the selector plate 240 and the corresponding locking elements or struts 206A, 206B align, one or both of the locking elements or struts 206A, 206B extends through and past the opening in the selector plate 240 and engage the notches 208 in the side surface 210 of the carrier 12. For example, in one position of the selector plate 240, the openings are oriented such that locking element or strut 206A is deployed and locking element 206B is not deployed. In another position, the openings of the selector plate 240 are oriented such that the locking element or strut 206A is nondeployed and the locking element 206B is deployed. The openings of the selector plate 240 may also be oriented such that both locking elements or struts 206A. 206B are deployed or neither are deployed. In the alternative example, the selector plate 240 of the first coupling assembly 200 is adjustable between different positions to implement different operating modes, including a mode wherein the differential is connected and disconnected.

The actuator 230 also controls the locking elements or struts 216A, 216B of the second coupling assembly. Deploying the locking elements or struts 216A, 216B and the forward locking element or strut 206A produces a mode wherein the differential is connected, and the locking differential or locker is on or connected.

In the alternative embodiment, the locking elements or struts 216A, 216B are both oriented and transmit torque in the same direction, for example, when deployed both locking elements or struts 216A, 216B, engage and transmit torque in a direction corresponding with reverse vehicle motion. The orientation and torque transmitting direction of the locking elements or struts 216A, 216B may be changed, for example, to corresponding to forward vehicle motion. If so, the reverse locking element or strut 206B needs to be deployed to produce a mode wherein the differential is connected, and the locking differential or locker is on or connected.

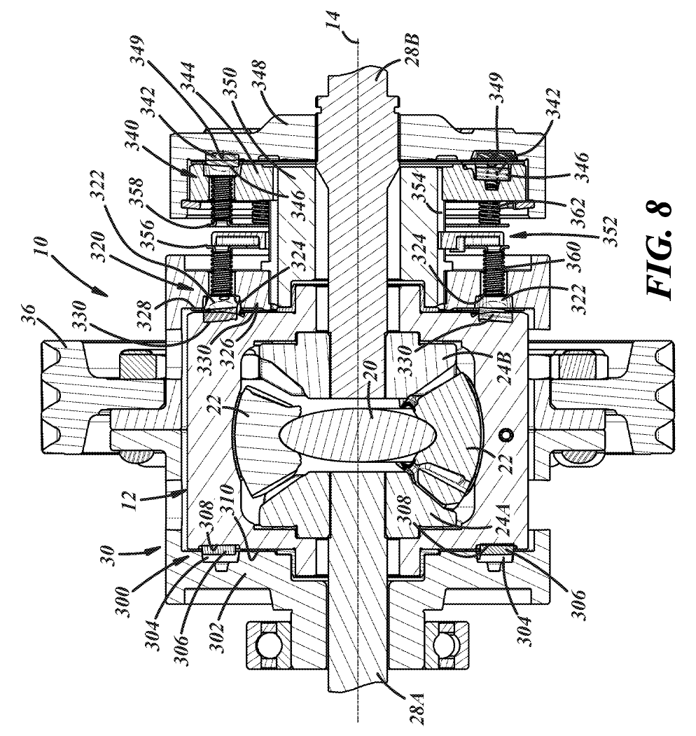

FIG. 8 illustrates yet another example of a drivetrain component 10 having a differential disconnect and a locker or lock feature. The drivetrain component 10 includes a case 30 and a carrier 12. A ring gear 36 is connected to the case, and the carrier 12 is rotatably supported in the case 30 for rotation about a rotational axis 14. The carrier 12 includes a differential gearset including a pinion shaft 20, pinion gears 22, and differential gears 24A, 24B. The left side differential gear 24A includes a plurality of splines used to connect the left side differential gear 24A to a left side half shaft or axle 28A.

The drivetrain component includes a first coupling assembly, seen generally at 300. The first coupling assembly 300 includes the case 30 having a radially extending plate portion forming a pocket plate 302. The pocket plate 302 is connected to and rotates with the ring gear 36.

The pocket plate 302 includes a pocket 304 with a locking element or strut 306 positioned in the pocket 304 and interacting with a corresponding notch 308 in a side surface 310 of the carrier 12. The locking element or strut 306 engages the corresponding notch 308 to couple the case to the carrier 12 and correspondingly transfer torque from the ring gear to the carrier. The first coupling assembly 300 is a one-way or overrunning clutch, for example, a passive one-way clutch wherein the locking element or strut 306 constantly extends from the pocket 304. The one-way clutch imposes torque in one direction and overruns in the opposite direction. The overrun state effectively or passively disconnects the case 30 and the carrier 12, and correspondingly disconnects the drive or power source from the wheels.

The drivetrain component 10 further includes a half shaft or axle 28B, which is connected to the differential gear 24B. A radially extending member 348 is fixed to the half shaft or axle 28B and rotates with the half shaft or axle 28B. An axially extending member or shaft 350 is fixed to the case 30 and rotates with the case 30.

The drivetrain component 10 also includes a second coupling assembly, generally shown at 320. The second coupling assembly 320 includes a locking element or strut 322 in a pocket 324 of a plate-like member, or pocket plate 326, which is connected to the case 30 and ultimately to the ring gear 36. A side surface 328 of the carrier 12 includes a notch 330. The notch 330 is configured to receive the locking element or strut 322.

The drivetrain component 10 further includes a third coupling assembly 340. The third coupling assembly 340 includes a radially extending member 344 fixed to the axially extending shaft 350 and ultimately connected to the case 30. A locking element or strut 342 is positioned in a pocket 346 in the radially extending member 344, which may be referred to as a pocket plate. The third coupling assembly 340 also includes a radially extending member 348 fixed to and rotating with the half shaft or axle 28B. The radially extending member 348 includes a plurality of notches 349 and may be referred to as a notch plate. The notches 349 are configured to receive the locking element or strut 342.

The drivetrain component 10 includes an actuator 352 that operates or controls the second and third coupling assemblies 320, 340. The actuator 352 includes a translator 354, spring plates 356, 358, and actuation springs 360, 362. The actuator operates through the translator 354, which moves axially on the axially extending shaft 350. In the present example, the actuator 352 is a three-position actuator movable between a first, second, and third position. When the translator 354 moves to the first or far left position, the locking elements or struts 322 of the second coupling assembly 320 are nondeployed and remain in the pocket 324 of the pocket plate 326. In the first position, the locking elements or struts 342 of the third coupling assembly 340 are nondeployed, and they remain in the pocket 346 of the pocket plate or radially extending member 344. In the first position, the drive train component 10 is in a mode in which the differential is disconnected and the locking element or locker is unlocked. When the translator 354 moves to the second or middle position, the locking elements or struts 322 of the second coupling assembly 320 are deployed and engage the notches 330 in the notch plate 332, and the locking elements or struts 342 of the third coupling assembly 340 are nondeployed, remain in the pocket 346 of the pocket plate radially extending member 344. In the second position, the drivetrain component 10 is in a mode in which the differential is connected and the locking element, or locker, is unlocked. When the translator 354 moves to the third or far right position, the locking elements or struts 322 of the second coupling assembly 320 are deployed and engage the notches 330 in the notch plate 332, and the locking elements or struts 342 of the third coupling assembly 340 are also deployed, extend from in the pocket 346 of the pocket plate or radially extending member 344 and engage notches 349 in the notch plate or radially extending member 348. In the third position, the drivetrain element is in a mode in which the differential is connected and the locking element, or locker, is locked.

The third coupling assembly 340 is disclosed as a controllable one-way clutch, including controllable locking elements or struts 342. The third coupling assembly 340 may also include a dog clutch or a friction clutch acting between the radially extending member 344 and the radially extending member 348. Wherein the dog clutch or friction clutch is controllable to fix or connect the half shaft or axle 28B to the case 30.

In the example of FIG. 1, the struts 58A, 58B controlling the differential disconnect are on the same side of the carrier 12. This arrangement or configuration may be referred to as a single plane disconnect. The struts 58A transfer torque in one direction, and the struts 58B transfer torque in the other direction. When only the struts 58A are deployed, the differential is disconnected, and when both struts 58A, 58B are deployed, the differential is connected. In another example, the struts 58A of the first coupling assembly 60 may be on one side of the carrier 12, and the struts 58B may be on the opposite or second side of the carrier 12. This arrangement or configuration may be referred to as a dual plane disconnect; see, for example, FIG. 8. In the example of FIG. 1, the second coupling assembly 62 is also located on the same side as the struts 58A, 58B, wherein at least struts 58B and 82A, 82B are controlled by a single actuator.

In one example, the drivetrain component 10 utilizes three coupling assemblies, at least two of which are controlled by an actuator. Two of the coupling assemblies couple the case to the carrier, and the third coupling assembly couples the axle or shaft to the case. Additional examples include one of the couplings between the case and the carrier being a passive coupling, and the other being an active or controllable coupling. In addition, all three locking elements may be controllable.

The foregoing examples disclose a drivetrain component 10 providing an electronically controlled, overrunning drivetrain disconnect and locking differential having a plurality of operating modes that can be both actively and passively controlled. The electronically controlled, overrunning drivetrain disconnect has a plurality of operating modes, in one example controlled by a single actuator. In one example, a three-position actuator controls the coupling assemblies. The examples disclose a combined locker or locking differential and a differential disconnect that share common components, including an actuator and/or multiple clutches packaged into a single differential.

As disclosed, the operating modes may include a forward operating mode wherein forward torque is controlled passively, a reverse operating mode, a regenerative operating mode, a disconnect operating mode, a non-synchronous clutch mode, meaning the driving member does not have to synchronize its rotational speed with the clutch before it can re-engage the driven member, and a locking or locker mode creating or forming a locked differential.

The indefinite articles "a" and "an," as used in the specification and in the claims, should be understood to mean "at least one," and should not be limited to "only one" unless explicitly indicated to the contrary.

As used herein in this document “or” means “and/or.” For example, “A or B means A without B, B without A, or A and B.

While examples or exemplary embodiments are described above, it is not intended that these embodiments describe all possible forms of the present invention. The words used in the specification are words of description rather than limitation, and it is understood that various changes may be made without departing from the spirit and scope of the present invention. Additionally, the features of various implementing embodiments may be combined to form further embodiments of the present invention.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A drivetrain component comprising:
a case;
a carrier, rotatably supported in the case for rotation about a rotational axis;
a differential gearset supported in the carrier, the differential gear set including a first differential gear connected to a first shaft and a second differential gear connected to a second shaft;
a first coupling assembly mechanically coupling the case to the carrier; and
a second coupling assembly mechanically coupling the first shaft or the second shaft to the case.

2. The drivetrain component of claim 1, wherein:
the first coupling assembly includes a locking element interacting between the case and the carrier; and
the second coupling assembly includes a locking element interacting between the case and the first shaft or the second shaft.

3. The drivetrain component of claim 1, wherein:
the first coupling assembly includes a plate-like portion connected to the case, the plate-like portion having a plurality of pockets and a plurality of locking elements, each locking element located in a corresponding pocket wherein the locking elements engage and couple the case to the carrier.

4. The drivetrain component of claim 1, wherein:
the second coupling assembly includes a plate-like portion connected to the case, the plate-like portion having a plurality of pockets and a plurality of locking elements, each locking element located in a corresponding pocket, wherein the locking elements engage and couple the case to the first shaft or the second shaft.

5. The drivetrain component of claim 1, wherein:
the first coupling assembly includes a plate-like portion connected to the case, the plate-like portion having a first plurality of pockets and a first plurality of locking elements associated with the first plurality of pockets wherein the locking elements engage and couple the case to the carrier; and
the second coupling assembly includes the plate-like portion having a second plurality of pockets and a second plurality of locking elements associated with the second plurality of pockets wherein the second plurality of locking elements engage and couple the case to the first shaft or the second shaft.

6. The drivetrain component of claim 1, including:
an actuator actuating the first coupling assembly and the second coupling assembly to control an operating mode of the drivetrain component.

7. The drivetrain component of claim 1, including:
the carrier, rotatably supported in the case for rotation about a rotational axis in a first direction of rotation and a second direction of rotation;
the first coupling assembly mechanically coupling the case to the carrier for torque transmission from the case to the carrier in the first direction of rotation; and
a third coupling assembly mechanically coupling the case to the carrier for torque transmission from the case to the carrier in the second direction of rotation.

8. The drivetrain component of claim 7, wherein:
the first coupling assembly includes a passive one-way clutch; and
the third coupling assembly includes an active one-way clutch.

9. The drivetrain component of claim 8, wherein:
the second coupling assembly includes an active one-way clutch.

10. A drivetrain component, comprising:
a case;
a carrier, rotatably supported in the case for rotation about a rotational axis;
a differential gearset supported in the carrier, the differential gear set including a first differential gear connected to a first shaft and a second differential gear connected to a second shaft;
a first coupling assembly mechanically coupling the case to the carrier;
a second coupling assembly mechanically coupling the case to the carrier;
an axially extending member connected the case; and
a third coupling assembly mechanically coupling the case to the first shaft or the second shaft.

11. The drivetrain component of claim 10, wherein:
the first coupling assembly includes a one-way clutch; and
the second coupling assembly includes a one-way clutch.

12. The drivetrain component of claim 10, wherein:
the first coupling assembly includes a passive one-way clutch;
the second coupling assembly includes an active one-way clutch; and
the third coupling assembly includes an active one-way clutch.

13. The drivetrain component of claim 10, wherein:
the third coupling assembly includes a notch plate connected to the first shaft and a pocket plate connected to the case, and a locking element disposed in a pocket of the pocket plate wherein the locking element engages the notch plate connected to the first shaft to couple the first shaft to the case.

14. The drivetrain component of claim 10, wherein:
an actuator actuating the first coupling assembly and the third coupling assembly to control an operating mode of the drivetrain component.

15. A drivetrain component, comprising:
a carrier, rotatably supported for rotation about a rotational axis;
a differential gearset supported in the carrier, the differential gear set including a first differential gear connected to a first shaft and a second differential gear connected to a second shaft;
a first coupling assembly mechanically coupling the carrier to the first shaft including a first notch plate connected to the carrier and a pocket plate connected to the first shaft; the first coupling assembly including a locking element; and
a second coupling assembly mechanically coupling the first shaft to an output shaft.

16. The drivetrain component of claim 15, wherein:
the first coupling assembly includes a one-way clutch; and
the second coupling assembly includes a one-way clutch.

17. The drivetrain component of claim 15, wherein:
the first coupling assembly includes a notch plate connected to the carrier and a first pocket plate connected to the first shaft; the first coupling assembly includes a locking element disposed in a pocket of the first pocket plate wherein the locking element engages the notch plate connected to the carrier to couple the first shaft to the carrier; and
the second coupling assembly includes a notch plate connected to the output shaft and a second pocket plate connected to the first shaft, the second coupling assembly includes a locking element disposed in a pocket of the second pocket plate wherein the locking element engages the notch plate connected to the output shaft to couple the first shaft to the output shaft.

18. The drivetrain component of claim 15, wherein:
an actuator actuating the first coupling assembly and the second coupling assembly to control an operating mode of the drivetrain component.

19. The drivetrain component of claim 15, wherein:
the first coupling assembly includes an active one-way clutch; and
the second coupling assembly includes an active one-way clutch.

20. The drivetrain component of claim 15, wherein:
the carrier, rotatably supported for rotation about the rotational axis in a first direction of rotation and a second direction of rotation;
the first coupling assembly mechanically coupling the carrier to the first shaft for torque transmission from the carrier to the first shaft in the first direction of rotation and the second direction of rotation; and
the second coupling assembly mechanically coupling the first shaft to the output shaft for torque transmission from the first shaft to an output shaft in the first direction of rotation and the second direction of rotation.
